(19) United States
(12) Patent Application Publication
(10) Pub. No.: US 2014/0150485 A1
(43) Pub. Date: Jun. 5, 2014

(54) Storage Unit for a Drive System in a Vehicle

(71) Applicant: BASF SE, Ludwigshafen (DE)

(72) Inventors: Mathias Weickert, Ludwigshafen (DE); Stefan Marx, Dirmstein (DE); Ulrich Müller, Neustadt (DE); Christian-Andreas Winkler, Mannheim (DE)

(73) Assignee: BASF SE, Ludwigshafen (DE)

(21) Appl. No.: 14/090,231

(22) Filed: Nov. 26, 2013

Related U.S. Application Data
(60) Provisional application No. 61/731,492, filed on Nov. 30, 2012.

(51) Int. Cl. H01M 10/50

(52) U.S. Cl. CPC H01M 10/5004
USPC 62/259.2

(57) ABSTRACT

Described is a storage unit for a drive system in a vehicle. The storage unit has at least one sorption store, at least one battery, and at least one cooling circuit. The sorption store is coupled via the cooling circuit to the battery. Further described is a method of operating the storage unit and also a drive system and a vehicle equipped with such a storage unit.

### CROSS-REFERENCE TO RELATED APPLICATIONS

This application claims the benefit of priority under 35 U.S.C. §119(e) to U.S. Provisional Application No. 61/731,492, filed Nov. 30, 2012, the entire content of which is incorporated herein by reference in its entirety.

### TECHNICAL FIELD

The invention relates to a storage unit for a drive system in a vehicle, which has at least one sorption store, at least one battery and at least one cooling circuit. The invention additionally relates to a method operating such a storage unit and also to a drive system and a vehicle comprising such a storage unit.

### BACKGROUND

To improve the efficiency and environmental friendliness of vehicles, electric motors are increasingly being used as drive apparatus. For example, internal combustion engines are combined with electric motors as auxiliary drive in hybrid vehicles in order to be able to operate the internal combustion engine under conditions more favorable to use. Electric motors are also used as main drive in purely electrically driven vehicles (electric vehicles) which are supplied with electric energy from a battery. Electric and hybrid vehicles typically comprise rechargeable batteries which, as electrochemical cell, convert chemical energy into electric energy. Such batteries are also often referred to as accumulator or secondary cell. However, a disadvantage of such batteries is that they are temperature-sensitive and can be operated optimally only within a range from about 0 to 50° C.

Owing to the increasing scarcity of oil resources, recourse is increasingly being made to unconventional fuels such as methane, ethanol or hydrogen for operating an internal combustion engine or a fuel cell. For this purpose, electric or hybrid vehicles comprise not only the battery for the electric motor but also a sorption store for keeping a stock of the fuel. Sorption stores suitable for such applications are, in particular, sorption stores which comprise an adsorption medium having a large internal surface area on which the gas is adsorbed and thereby stored. On filling the sorption store, heat is liberated as a result of adsorption.

Analogously, heat has to be supplied for the process of desorption when gas is taken from the store. When sorption stores and batteries are used, heat management is therefore of great importance.

DE 10 2009 000 952 A1 discloses a vehicle battery having at least one latent heat store which comprises a medium having a particular melting point. Here, the medium is selected so that the melting point is in the range from the minimum to the maximum operating temperature of the type of battery used. In this way, temperature fluctuations in an electrochemical energy store of the vehicle battery are avoided by targeted heat transfer between the integrated latent heat store and the electrochemical energy store.

DE 10 2006 052 110 A1 describes a fluid store having a sorption medium, which comprises an energy uptake and output device for improving energy management and for immediate provision of heat for the gas release process. The energy uptake and output device comprises bundles of tubes through which a fluid is conveyed in the interior of the fluid store. Furthermore, the fluid store is coupled via a cooling circuit with a latent heat store for the temporary storage of heat and with a heating element or a connection to an engine cooling circuit for aiding energy transfer.

DE 10 2010 048 478 A1 describes a heat management method for a battery, which controls the heat input into the battery. A battery temperature system which cools or heats the battery stack as a function of the ambient temperature is used for this purpose. In the cooling mode, heat is transferred from the battery stack to a coolant and given off to the environment via a battery radiator. In the heating mode, the coolant is heated by means of a heating facility before entering the battery stack.

DE 10 2008 054 216 A1 discloses a method of adjusting an electric drive in a vehicle. Here, at least one temperature of the electric drive, for instance of the stator or of the rotor, is determined and the temperature of part of the electric drive is set as a function of a parameter.

DE 10 2007 004 979 A1 describes an apparatus for controlling the temperature of a battery in a motor vehicle, in which the battery is integrated into a refrigeration circuit and a low-temperature cooling circuit of the vehicle. In an operating mode with the refrigeration circuit switched off, control of the battery temperature is effected by the low-temperature cooling circuit. In a further operating mode, preheating of the battery is achieved by conveying coolant via a bypass line around the battery before it enters the cooler of the low-temperature cooling circuit.

WO 2009/127 531 A1 discloses a liquid cooling apparatus for a fuel cell apparatus, which is configured as an independent unit and provides cooling liquid to the fuel cell apparatus or takes a heated liquid from the fuel cell apparatus.

DE 10 2008 040 211 A1 discloses a method for operating a fuel cell system, which comprises a fuel cell, a storage container and a battery.

US 2012/0141842 describes a fuel cell surrounded by a solid-state battery.

A disadvantage of known heat management systems for batteries or sorption stores is that additional components are needed for the introduction of heat, and these incur further costs and take up further construction space. In addition, the efficiency of latent storage systems is limited and the capacity cannot be fully exploited, for example on moving off. These disadvantages are particularly serious in mobile applications, for example in motor vehicles. There is, therefore, continuing interest in providing a very simple and efficient heat management concept for such storage systems.

### SUMMARY

A first aspect of the invention is directed to a storage unit for a drive system in a vehicle. In a first embodiment, a storage unit for a drive system in a vehicle comprises at least one sorption store, at least one battery, and at least one cooling circuit, wherein the sorption store is coupled via the cooling circuit to the battery, wherein the cooling circuit comprises at least one sorption store circuit and at least one battery circuit.

In a second embodiment, the storage unit of the first embodiment is modified, wherein the cooling circuit comprises at least one pump which conveys a refrigerant between the battery and the sorption store in the cooling circuit.

In a third embodiment, the storage unit of the first and second embodiments is modified, wherein the sorption store circuit and the battery circuit branch off from at least one main line.

In a fourth embodiment, the storage unit the first through third embodiments is modified, wherein at least one valve for regulating the refrigerant flow is provided in the sorption store circuit or in the battery circuit.

In a fifth embodiment, the storage unit of the first through fourth embodiments is modified, wherein a heat exchanger and/or at least one pump is arranged in the region of the main line of the cooling circuit.

In a sixth embodiment, the storage unit of the first through fifth embodiments is modified, wherein the sorption store circuit and the battery circuit form two separate circuits which are connected to one another in the circuit via a connecting line.

In a seventh embodiment, the storage unit of the first through sixth embodiments is modified, wherein the connecting line comprises at least one pump and at least one valve.

In an eighth embodiment, the storage unit of the first through seventh embodiments is modified, wherein the sorption store circuit and the battery circuit comprise at least one pump and at least one heat exchanger.

A second aspect of the invention is directed to a method of operating a storage unit. In a ninth embodiment, a method of operating the storage unit of the first embodiment comprises heat exchange between the battery and the sorption store via a cooling circuit to which at least one battery and at least one sorption store are connected.

In a tenth embodiment, the method of the ninth embodiment is modified, wherein the storage unit is operated as a function of a charging state of the battery, a fill level of the sorption store or both.

In an eleventh embodiment, the method of the ninth and tenth embodiments is modified, wherein a refrigerant is flown through the battery and the sorption store is varied as a function of the charging state of the battery, the fill level of the sorption store or both.

In a twelfth embodiment, the method according of the ninth through eleventh embodiments is modified, wherein a total stream of the refrigerant is divided into a sorption store circuit and a battery circuit.

A third aspect of the invention is directed to a drive system. In a thirteenth embodiment, a drive system comprises the storage unit of the first embodiment through eighth embodiments.

A fourth aspect of the invention is directed to a vehicle. In a fourteenth embodiment, a vehicle comprises the storage unit of the first through eighth embodiments.

### BRIEF DESCRIPTION OF DRAWINGS

FIG. 1 a drive system for a vehicle with storage unit according to the invention;

FIG. 2 a first embodiment of the storage unit according to the invention;

FIG. 3 a second embodiment of the storage unit according to the invention;

FIG. 4 a third embodiment of the storage unit according to the invention;

FIG. 5 a fourth embodiment of the storage unit according to the invention.

### DETAILED DESCRIPTION

Provided is a storage unit for fuel and electric energy which is equipped with very few additional components and by means of which efficient and simple heat management can be achieved. Also provided is a method of simply and efficiently regulating the temperature in a storage unit.

Provided is a storage unit which is, in particular, suitable for use in a drive system in a vehicle and has at least one sorption store, at least one battery and at least one cooling circuit, wherein the sorption store is coupled via the cooling circuit to the battery.

The invention further provides a method of operating a storage unit and also a method of operating a storage unit in a drive system having a motor unit comprising at least one internal combustion engine or at least one fuel cell and at least one electric motor. Here, heat is exchanged between the battery and the sorption store via a cooling circuit to which at least one battery and at least one sorption store are connected.

The invention also provides a drive system and a vehicle, in particular a hybrid vehicle, equipped with a storage unit according to the invention. Apart from vehicles, the storage unit of the invention can also be used in other mobile applications, for instance in the drive system of boats, in particular submarines. In addition, the storage unit of the invention is suitable for stationary applications, for example in conjunction with solar cells for heating a building or in combined heating and power stations.

The storage unit of the invention couples the refrigerant-conveying cooling circuit to the sorption store and the battery. This enables the temperature of the two components to be regulated in a simple way, with heat from the battery being introduced into the sorption store and vice versa. When a vehicle is driven, the heat from the battery can, for example, be taken up by a refrigerant and conveyed via the cooling circuit to the sorption tank in order to provide the necessary heat for desorption of the fuel there. The sorption store thus provides cooling power which is utilized for cooling the battery. Excess cooling power from the sorption store can be utilized for other components, for example for air conditioning of the passenger compartment in the vehicle. Conversely, the battery provides the necessary heating power to activate desorption in the sorption store. When heat balance is achieved between the battery and the sorption store, it is even possible to dispense with further heat-introducing or temperature-controlling components. This allows a simple and efficient configuration of such storage units, which additionally require little installation space and are thus particularly suitable for mobile applications, for example in a vehicle.

For the purposes of the invention, sorption stores are stores which comprise an adsorption medium having a large surface area in order to adsorb gas and thereby store it. Thus, heat is liberated during filling of the sorption store, while the desorption is activated by introduction of heat. In particular, fuels such as methane, methanol, hydrogen, acetylene, propane or propene can be stored in the sorption store of the storage unit of the invention and be provided by desorption to an internal combustion engine or a fuel cell. Methane is particularly suitable as fuel for internal combustion engines. Fuel cells are preferably operated using methanol or hydrogen.

As used herein, the term “battery” refers to rechargeable secondary cells or accumulators which convert chemical energy into electric energy. Specific batteries are lead-based accumulators such as lead-acid accumulators, nickel-based accumulators such as nickel-cadmium accumulators, nickel-hydrogen accumulators, nickel-metal hydride accumulators, nickel-iron accumulators or nickel-zinc accumulators, lithium-based accumulators such as lithium-sulfur accumulators, lithium ion accumulators, lithium-polymer accumulators, lithium-metal accumulators, lithium-manganese accumulators, lithium iron phosphate accumulators, lithium titanate accumulators or tin-sulfur-lithium accumulators, sodium-based accumulators such as sodium-sulfur accumulators or sodium nickel chloride accumulators, silver-zinc accumulators, silicone accumulators, vanadium redox accumulators or zinc-bromine accumulators. Here, the storage unit of the invention can comprise one or more of the abovementioned batteries of the same type or different types.

In specific embodiments, the batteries are lithium-based accumulators, in particular lithium ion accumulators or lithium-sulfur accumulators, lead-based accumulators, nickel-based accumulators or sodium-based accumulators.

In one embodiment of the storage unit of the invention, the cooling circuit comprises at least one pump which conveys the refrigerant. Depending on the temperature range which is suitable for cooling or heating the fuel in the sorption store and the battery, various refrigerants are possible, for example water, glycols, alcohols or mixtures thereof. Appropriate refrigerants are known to those skilled in the art.

In an embodiment of the storage unit of the invention, the cooling circuit comprises at least one sorption store circuit and at least one battery circuit. In a variant of the cooling circuit, the sorption circuit and the battery circuit branch off from at least one main line. Here, the total stream of the refrigerant of the main line can be divided between the sorption store circuit and the battery circuit. To divide the total stream of the refrigerant variably between the two circuits, at least one valve can be provided at least in the sorption circuit or the battery circuit. In one or more embodiments, the sorption store circuit and the battery circuit comprise at least one valve which is located upstream of the sorption store and of the battery in order to control the flow of refrigerant into the respective component.

In the cooling circuit having a sorption store circuit and a battery circuit branching off from the main line, the pump can be arranged for conveying the refrigerant in the region of the main line of the cooling circuit. In addition, a heat exchanger can be arranged in the region of the main line of the cooling circuit in order to regulate the temperature of the refrigerant. Possible heat exchangers are adequately known to those skilled in the art. For example, plate heat exchangers, spiral heat exchangers, shell- and tube heat exchangers or microchannel heat exchangers are suitable.

In a further embodiment, the sorption store circuit and the battery circuit form two separate circuits which are connected to one another in the circuit via a connecting line. In one or more embodiments, the connecting line comprises at least one pump and at least one valve. Here, the pump can be arranged in the branch of the connecting line which opens into the battery circuit. The valve can be arranged in a further branch of the connecting line which opens into the sorption store circuit. Thus, the refrigerant can be conveyed by the pump in the circuit between the battery circuit and the sorption store circuit, with the valve regulating the refrigerant flow between the battery circuit and the sorption store circuit.

In a further embodiment of the storage unit of the invention, the sorption store circuit and the battery circuit can comprise at least one pump and at least one heat exchanger. In one or more embodiments, the pump is arranged so that the refrigerant is conveyed through the battery or the sorption tank and subsequently through the heat exchanger. The pump is thus located upstream of the battery in the battery circuit or of the sorption store in the sorption circuit. In one or more embodiments, the heat exchanger serves to regulate the temperature and is located downstream of the battery in the battery circuit or of the sorption store in the sorption circuit. Possible heat exchangers are adequately known to those skilled in the art. For example, plate heat exchangers, spiral heat exchangers, shell- and tube heat exchangers or micro channel heat exchangers are suitable.

The sorption store for storing the gaseous fuel can comprise a closed vessel. The vessel can, in its interior, have at least one dividing element which is configured in such a way that the interior of the vessel is divided into at least one channel pair of two parallel, channel-shaped subchambers and each channel-shaped subchamber is at least partly filled with an adsorption medium. The ends of the subchambers can be separated from one another or be connected to one another via in each case a joint space.

Furthermore, the sorption store can be equipped with a feed device which comprises at least one passage through the vessel wall through which a gas can flow into the vessel. The feed device can comprise, for example, an inlet and an outlet which can each be closed by means of a shutoff device. In one or more embodiments, the feed device is configured so that inflowing gas is at least partly directed into one of the two subchambers per channel pair.

The division of the interior of the vessel into channel-shaped subchambers connected to one another in pairs in combination with the feed device results in a flow circulating through the channels being established during filling or emptying of the vessel. This gives improved heat transfer to the vessel wall, which is usually cooled during filling and/or heated during emptying. As a result of rapid cooling or heating of the gas in the vessel, larger amounts of gas can be adsorbed or desorbed in the same time.

An improvement in heat transfer can be achieved when not only the vessel wall but also the at least one dividing element, or in the case of a plurality of dividing elements one or more thereof, are cooled or heated. For this purpose, the at least one dividing element or a plurality of dividing elements, in particular all dividing elements present, can be configured as double walls so that a refrigerant can flow through them.

In a further embodiment of the sorption store, the channel walls of the channel-shaped subchambers are configured as double walls for a refrigerant to flow through them. Depending on the arrangement of the at least one dividing element or the plurality of dividing elements, a section of the vessel wall forms a channel wall of a channel-shaped subchamber or a plurality of channel-shaped subchambers. In this case, the container wall is also configured as a double wall. In a particularly specific embodiment, the entire vessel wall including the end faces is configured so as to allow a refrigerant to flow through it, in particular configured as a double wall.

Such a construction of the sorption store with refrigerant-conveying channel walls makes rapid heat transport from the adsorption medium or into the adsorption medium possible. As a result, the store can be filled with a larger amount of gas in a given period of time. When gas is taken from the store, rapid and constant provision of gas is also ensured. For this purpose, the channel walls are heated, for example in the case of the double-walled configuration a refrigerant of the cooling circuit whose temperature is greater than the temperature of the gas in the channel-shaped subchambers flows through the channel walls. The sorption store is simple in terms of construction and due to its compact construction is particularly suitable for mobile applications, for example in vehicles. The configuration with double-walled channel walls additionally has the advantage that for switching from cooling to heating, it is merely necessary for the refrigerant to be changed or its temperature to be altered appropriately. Thus, this embodiment is, in mobile use, equally suitable for filling with fuel and for the traveling mode.

The choice of the wall thickness of the vessel and of the dividing elements is dependent on the maximum pressure to be expected in the vessel, the dimensions of the vessel, in particular its diameter, and the properties of the material used. In the case of an alloy steel vessel having an external diameter of 10 cm and a maximum pressure of 100 bar, for example, the minimum wall thickness has been estimated as 2 mm (in accordance with DIN 17458). The gap width of the double walls is selected so that a sufficiently large volume flow of the refrigerant can flow through them. In one or more embodiments, the gap width is from 2 mm to 10 mm, specifically from 3 mm to 6 mm.

It has been found to be advantageous for the spacing of the channel walls in each channel-shaped subchamber to be from 2 cm to 8 cm. Here, the spacing is the shortest distance between two points on opposite walls in cross section perpendicular to the channel axis. In the case of a channel having a circular cross section, for example, the spacing corresponds to the diameter, in the case of an annular cross section the width of the annulus and in the case of a rectangular cross section the shorter distance between the parallel sides. Particularly in the case of cooling or heating of all channel walls, the abovementioned range has been found to be a good compromise between heat transfer and fill volume of the adsorption medium. In the case of larger spacings, the heat transfer between absorption medium and wall deteriorates, while at smaller spacings the fill volume of the adsorption medium decreases at given external dimensions of the vessel. In addition, the weight of the sorption store and its manufacturing costs increase, which is disadvantageous, especially in mobile applications.

In a specific embodiment, the spacings of the channel walls in the channel-shaped subchambers differ within channel pairs by not more than 40%, specifically by not more than 20%. The spacings of the channel walls in all channel-shaped subchambers differ by not more than 40%, specifically by not more than 20%, from one another. Such a configuration favors uniform removal of heat during filling and supply of heat during emptying of the vessel.

Viewed in cross section, the contours of the interior wall of the vessel and of at least one dividing element are essentially conformal. If a plurality of dividing elements are present, the contours of all dividing elements are conformal to the contour of the interior wall of the vessel. As used herein, the term “conformal” means that the contours have the same shape, for example they are all circular, all elliptical or all rectangular. The term “essentially conformal” means that small deviations from the basic shape do not mean that the shapes are no longer the same. Examples are rounded corners in the case of a rectangular basic shape or deviations within manufacturing tolerances.

In a further embodiment, the vessel of the sorption store has a cylindrical shape and the at least one dividing element is arranged essentially coaxially to the cylinder axis. Embodiments in which the longitudinal axis of the at least one dividing element is inclined by a few degrees up to a maximum of 10 degrees relative to the cylinder axis are still considered to be “essentially” coaxial. This embodiment ensures that the channel cross sections vary only slightly along the cylinder axis, so that uniform flow over the length of the channel can be established.

Depending on the installation space available and the maximum permissible pressure in the vessel, different cross-sectional areas are suitable for the cylindrical vessel, for example circular, elliptical or rectangular. Irregularly shaped cross-sectional areas are also possible, e.g. when the vessel is to be fitted into a hollow space of a vehicle body. For high pressures above about 100 bar, circular and elliptical cross sections are particularly suitable. In this specific embodiment, the at least one dividing element is configured as a tube so that the interior space of the tube forms a first channel-shaped subchamber and the space between the outer wall of the tube and the interior wall of the vessel or optionally between the outer wall of the tube and a further dividing element forms a second, annular channel-shaped subchamber. In one or more embodiments, the cross-sectional areas of the vessel and of the tubular dividing element have the same shape, for example both circular or both elliptical. In a further development of this embodiment according to the invention, a plurality of dividing elements which are all configured as tubes having different diameters and are arranged coaxially are present. In one or more embodiments, their cross-sectional areas likewise have the same shape.

Various materials are suitable as adsorption medium for the sorption store. In one or more embodiments, the adsorption medium comprises zeolite, activated carbon or metal-organic frameworks (MOFs). In a specific embodiment, the adsorption medium comprises metal-organic frameworks (MOFs).

Zeolites are crystalline aluminosilicates having a microporous framework structure made up of AlO₄⁻ and SiO₄ tetrahedra. Here, the aluminum and silicon atoms are joined to one another via oxygen atoms. Possible zeolites are zeolite A, zeolite Y, zeolite L, zeolite X, mordenite, ZSM (Zeolites Socony Mobil) 5 or ZSM 11. Suitable activated carbons are, in particular, those having a specific surface area above 500 m² g⁻¹, specifically above 1500 m² g⁻¹, very specifically above 3000 m² g⁻¹. Such an activated carbon can be obtained, for example, under the name Energy to Carbon or MaxSorb.

Metal-organic frameworks are known in the prior art and are described, for example, in U.S. Pat. No. 5,648,508, EP-A-0 790 253, M. O'Keeffe et al., J. Sol. State Chem., 152 (2000), pages 3 to 20, H. Li et al., Nature 402, (1999), page 276, M. Eddaoudi et al., Topics in Catalysis 9, (1999), pages 105 to 111, B. Chen et al., Science 291, (2001), pages 1021 to 1023, DE-A-101 11 230, DE-A 10 2005 053430, WO-A 2007/054581, WO-A 2005/049892 and WO-A 2007/023134. The metal-organic frameworks mentioned in EP-A-2 230 288 A2 are particularly suitable for sorption stores. Specific metal-organic frameworks are MIL-53, Zn-tBu-isophthalic acid, Al-BDC, MOF 5, MOF-177, MOF-505, MOF-A520, HKUST-1, IRMOF-8, IRMOF-11, Cu-BTC, Al-NDC, Al-AminoBDC, Cu-BDC-TEDA, Zn-BDC-TEDA, Al-BTC, Cu-BTC, Al-NDC, Mg-NDC, Al-fumarate, Zn-2-methylimidazolate, Zn-2-aminoimidazolate, Cu-biphenyldicarboxylate-TEDA, MOF-74, Cu-BPP, Sc-terephthalate. Greater preference is given to MOF-177, MOF-A520, HKUST-1, Sc-terephthalate, Al-BDC and Al-BTC.

In one or more embodiments, the porosity of the adsorption medium is at least 0.2. The porosity is defined here as the ratio of hollow space volume to total volume of any subvolume in the vessel of the sorption store. At a lower porosity, the pressure drop on flowing through the adsorption medium increases, which has an adverse effect on the filling time.

In a specific embodiment of the invention, the adsorption medium is present as a bed of pellets and the ratio of the permeability of the pellets to the smallest pellet diameter is at least 10-14 m²/m. The rate at which the gas penetrates into the pellets during filling depends on the rapidity with which the pressure in the interior of the pellets becomes the same as the ambient pressure. With decreasing permeability and increasing diameter of the pellets, the time for this pressure equalization and thus also the loading time of the pellets increases. This can have a limiting effect on the overall process of filling and discharging.

In an embodiment of the method of the invention for operating the storage unit, which can be integrated in a drive system, the storage unit is operated as a function of a charging state of the battery, a fill level of the sorption store or both. Here, in particular, a refrigerant flow through the battery and the sorption store is varied as a function of the charging state of the battery, the fill level of the sorption store or both.

In a further embodiment of the method of the invention, the refrigerant flow for an at least half-charged battery is set so that the battery is supplied with sufficient cooling power. As used herein, the expression “half-charged battery” refers to a battery which has essentially 50% of the total capacity. Sufficient cooling power for the battery is present when the temperature of the battery is maintained in the range from −30° C. to 50° C., specifically from −10° C. to 40° C. and very specifically from 0° C. to 35° C., by the cooling circuit.

In a further embodiment of the method of the invention, the refrigerant flow for a battery which is charged to less than one quarter, specifically less than 10%, of the total capacity is set so that essentially no cooling power is supplied to the battery. As used herein, the expression less than one quarter charged refers to a battery which has not more than 25% of its total capacity. Essentially no cooling power means that the battery is cooled by air and cooling by the cooling circuit can be essentially stopped.

To implement the method of operating the storage unit, a pump can convey the refrigerant in the cooling circuit, with the refrigerant taking up heat from the battery or the sorption store and transferring it to the other component in each case. Here, a pumping power of the pump can be varied as a function of a charging state of the battery, a fill level of the sorption store or both.

In a further embodiment of the method of operating the storage unit, a total stream of the refrigerant is divided into a sorption store circuit and a battery circuit. Here, the mass flow of the refrigerant in the sorption store circuit and in the battery circuit can be regulated by means of at least one valve in the sorption store circuit, in the battery circuit or in both circuits.

In an embodiment of the method of operating a storage unit in a drive system having a motor unit, the electric motor can in the case of an at least half-charged battery be more active than the internal combustion engine or the fuel cell. Furthermore, in the case of a battery which is charged to less than one quarter, specifically to less than 10%, of the total capacity, the internal combustion engine or the fuel cell can be more active than the electric motor. As used herein, the expression “more active” means that the respective more active motor component imparts a greater torque to the drive train.

In the method of the invention for operating a storage unit, in particular in a drive system, various configurations can be present depending on the charging state of the battery and fill level of the sorption store.

When the battery is essentially fully charged, in particular charged to more than 90% of the total capacity, and the sorption store is essentially full, in particular filled to more than 90% of the total capacity, preference is given to both the electric motor and the internal combustion engine or the fuel cell being utilized for powering the vehicle.

In this illustrative configuration, the valves of the cooling circuit can be set so that the cooling power is sufficient for the battery. The sorption store can be emptied more slowly corresponding to the adsorption enthalpy. The electric motor can then be more active than the internal combustion engine or the fuel cell, and both the valve for the battery circuit and the valve for the sorption store circuit can be fully opened.

If the battery is less than one quarter charged, specifically charged to less than 10% of the total capacity, and the sorption store is at least half full, in particular filled to 50% of the total capacity, preference is given to utilizing the internal combustion engine or the fuel cell for powering the vehicle.

In this illustrative configuration, the battery requires only cooling by means of air for a low power offtake and cooling by means of the cooling circuit can be stopped. The sorption store can become active depending on the traveling mode. The valves can be set so that the valve for the battery circuit can be closed and the valve for the sorption store circuit can be fully opened.

If the battery is less than one quarter charged, specifically charged to less than 10% of the total capacity, and the sorption store is essentially full, in particular filled to more than 90% of the total capacity, preference is given to utilizing the internal combustion engine or the fuel cell for powering the vehicle.

In this illustrative configuration, the battery requires only cooling by means of air for a low power offtake and cooling by the cooling circuit can be stopped. The sorption store can become active as a function of the traveling mode. The valves can accordingly be set so that the valve for the battery circuit can be closed and the valve for the sorption store circuit can be fully opened.

If the battery is at least half-charged, in particular charged to 50% of the total capacity, and the sorption store is at least half full, in particular filled to 50% of the total capacity, preference is given to utilizing both the electric motor and the internal combustion engine or the fuel cell for powering the vehicle.

In this illustrative configuration, the valves can be set so that the cooling power is sufficient for the battery. The sorption store can be emptied more slowly corresponding to the adsorption enthalpy. The electric motor can then be more active than the internal combustion engine and both the valve for the battery circuit and the valve for the sorption store circuit can be fully opened.

If the battery is essentially fully charged, in particular charged to more than 90% of the capacity, and the sorption store is less than one quarter full, specifically filled to less than 10% of the total capacity, preference is given to utilizing both the electric motor and the internal combustion engine or the fuel cell for powering the vehicle.

In this illustrative configuration, the valves of the cooling circuit can be set so that the cooling power is sufficient for the battery. The sorption store can be emptied more slowly corresponding to the adsorption enthalpy. The electric motor can then be more active than the internal combustion engine and both the valve for the battery circuit and the valve for the sorption store circuit can be fully opened.

The invention is illustrated below with the aid of drawings. However, the examples described and the aspects emphasized therein merely illustrate the principles and do not constitute a restriction of the invention. Rather, many modifications of the type which a person skilled in the art would routinely make are possible.

Referring to the figures, the following reference numerals are used:
10 Drive system
12 Storage unit
14 Motor unit
16 Battery
18 Sorption store
20 Fuel tank
20 Electric motor
21 Lines to the electric motor
22 Internal combustion engine
23 Lines to the internal combustion engine
24 Drive train
26 Cooling circuit
28 Pump
30 Lines of the cooling circuit
32, 33 Battery circuit
34, 35 Sorption store circuit
36, 38 Main line
40, 42 Valve
44.1, 44.2 Junction
46 Heat exchanger
48, 50 Connecting line
52, 56 Pump
54, 58 Heat exchanger
60 Valve

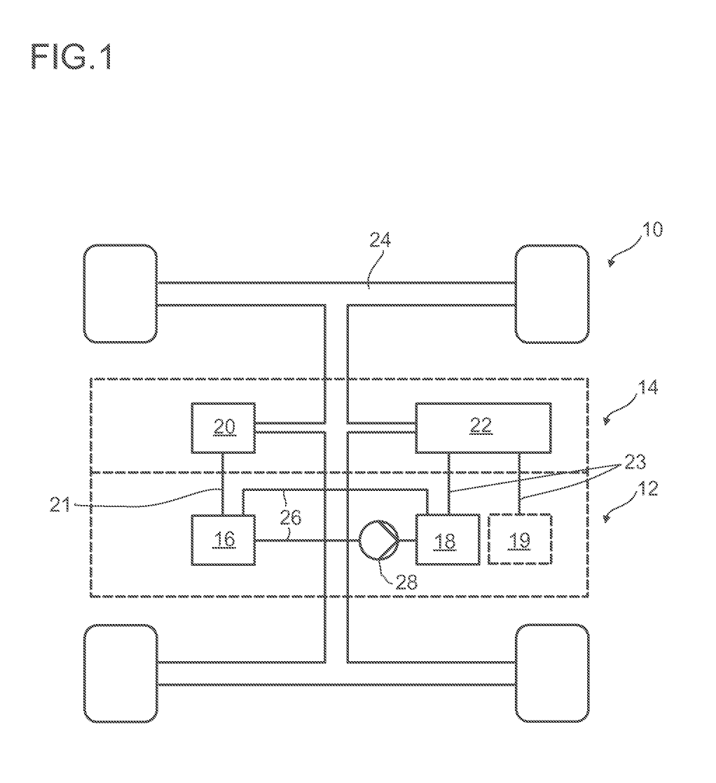

FIG. 1 shows a drive system 10, for instance for a hybrid vehicle, having a storage unit 12 according to the invention which comprises a battery 16, a fuel tank 18 configured as sorption store and optionally a further fuel tank 19.

The drive system 10 of FIG. 1 is equipped with a motor unit 14 which comprises an internal combustion engine 22 and an electric motor 20. Such drive systems 10 are particularly suitable for hybrid vehicles in which both combustion energy and electric energy are utilized for powering the vehicle. Thus, the internal combustion engine 22 can supply energy to the drive axle 24 of the hybrid vehicle by combustion of a fuel from a fuel tank 18, 19 and/or the electric motor 20 can supply energy to the drive axle 24 of the hybrid vehicle by means of electric energy stored in a battery 16.

Apart from the system architecture shown, in which the internal combustion engine 22 and the electric motor 20 act in parallel on the drive train 24, it is also possible to conceive of a series system architecture. Here, only the electric motor 20 acts directly on the drive train 24 and the internal combustion engine 22 charges the battery 16 via a generator located in between.

In the embodiment of FIG. 1, the storage unit 12 according to the invention comprises a fuel tank 18 which is configured as sorption store and a battery 16 for storing electric energy. The sorption store 18 is filled with a fuel which can be fed to the internal combustion engine 18 via a line 23. The sorption store 18 comprises an adsorption medium having a large internal surface area on which the fuel is adsorbed and stored. Thus, heat is liberated as a result of adsorption when filling the sorption store 18 and this heat has to be removed from the sorption store 18. Analogously, when fuel is taken off from the sorption store 18, heat for the process of desorption has to be supplied. Heat management is therefore of great importance in the design of such drive systems 10.

For this purpose, the storage unit 12 according to the invention provides for coupling of the sorption store 18 with the cooling circuit 26 of the battery 16. Thus, the sorption store 18 is integrated into the cooling circuit 26 of the battery 16. The cooling circuit 26 conveys a refrigerant, which is, for example, circulated by means of a pump 28 between the battery 16 and the sorption store 18. In this way, the refrigerant can take up heat from the battery 16 and transfer it to the sorption store 18 during traveling operation. This results firstly in the battery 16 being cooled and secondly in heat being supplied to the sorption store 18 for desorption of the fuel. Conversely, the refrigerant can take up heat of adsorption during filling of the sorption store 18 and transfer it to the battery 16.

Apart from the sorption store 18 and the battery 16, the storage unit 12 according to the invention of the drive system 10 can comprise a further fuel tank 19 which keeps a further fuel in stock for the internal combustion engine 22 and can provide this to the internal combustion engine 22 via a line 23. For example, the fuel tank 19 can comprise a fuel tank for diesel or gasoline. Such fuel tanks 19 are used on a production scale in vehicles and are adequately known to those skilled in the art.

In other embodiments, the motor system 14 of the drive system 10 of FIG. 1 can comprise a fuel cell which converts the chemical reaction energy of a fuel which is continuously fed in and an oxidant into electric energy instead of the internal combustion engine 20. Suitable fuels are, for example, hydrogen, methane or methanol, from which the fuel cell generates electric energy using oxygen, in particular atmospheric oxygen, as oxidant. In this embodiment, too, the fuel can be kept in stock in a sorption store 18 which together with the battery 16 is integrated into the storage unit 12 according to the invention.

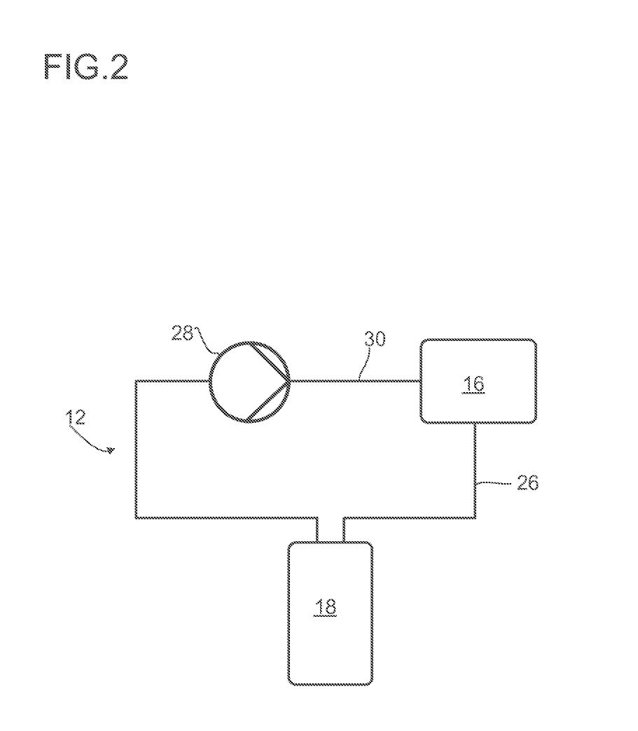

FIG. 2 shows a first embodiment of the storage unit 12 according to the invention, in which the sorption store 18 is coupled to the cooling circuit 26 of the battery 16.

In the simplest variant, the storage unit 12 according to the invention comprises a sorption store 18 which is connected to the cooling circuit 26 of the battery 16. Here, the cooling circuit 26 comprises lines 30 which convey the refrigerant and a pump 28 which pumps the refrigerant in a circuit between the sorption store 18 and the battery 16.

To store the fuel, the sorption store 18 comprises an adsorption medium which adsorbs the fuel with evolution of heat. Provision of the fuel for the internal combustion engine 22 or the fuel cell is effected by desorption with uptake of heat. To make this introduction of heat during traveling operation very simple and efficient, the storage unit of the invention provides for heat coupling between the sorption store 18 and the battery 16.

Thus, the refrigerant takes up heat which is evolved in the battery 16 during traveling operation and is introduced into the sorption store 18. There, the heat is transferred from the heated refrigerant to the adsorption medium in the sorption store 18 and utilized for desorption of fuel. From the sorption store 18, the fuel goes into the internal combustion engine 22 or the fuel cell in which energy is additionally generated for powering the vehicle by combustion of the fuel.

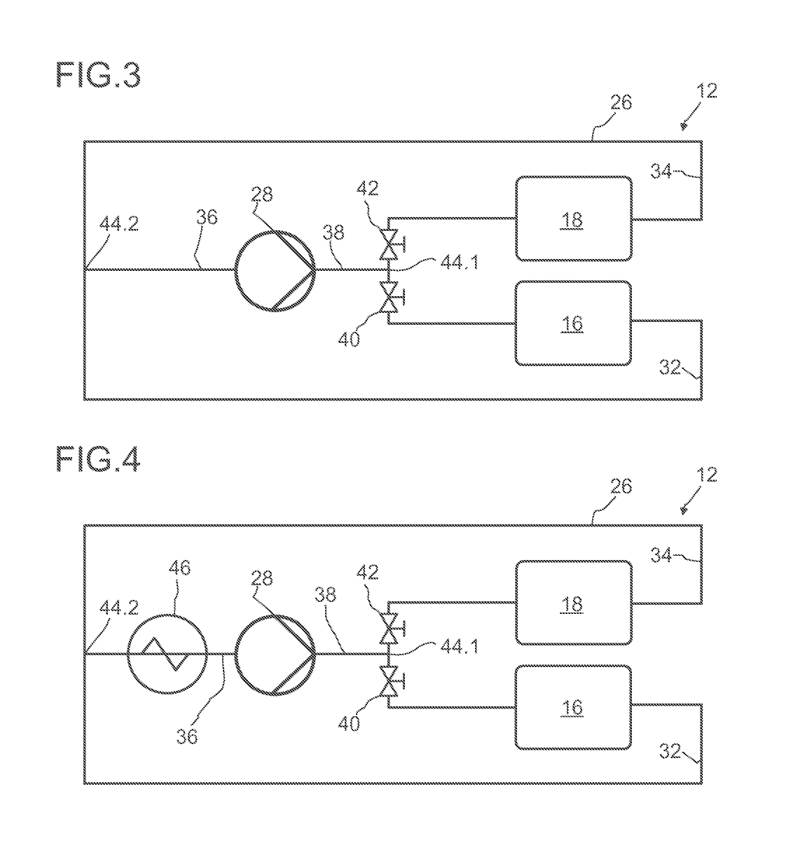

FIG. 3 shows a further embodiment of the storage unit 12 according to the invention, in which the cooling circuit 26 between the battery 16 and the sorption store 18 is operated in parallel. The storage system 12 of FIG. 3 likewise comprises a sorption store 18 which is connected to the battery 16 via a cooling circuit 26. In order to operate the cooling circuit 26 in parallel between the sorption store 18 and the battery 16, the cooling circuit 26 is divided into a battery branch 32, a sorption store branch 34 and a main line 36, 38. The pump 28 is arranged in the main line and conveys the refrigerant in the cooling circuit 26. Upstream and downstream of the pump there are junctions 44.1, 44.2 at which the two branches 32, 34 open into the main line 36, 38. Thus, the refrigerant is pumped from the main line 36, 38 into the battery branch 34 and the sorption store branch 34 and subsequently recirculated to the main line 36, 38.

To regulate the refrigerant flow in the battery branch 32 and in the sorption store branch 34, valves are arranged in the battery branch 32 and the sorption store branch 34. Thus, a valve 40 is provided in the battery branch 32 between the junction 44.1 and the battery 16 so as to regulate the refrigerant flow in the battery branch 32. Similarly, a valve 42 is provided in the sorption store branch 34 between the junction 44.1 and the sorption store 18 so as to regulate the refrigerant flow in the sorption store branch 34. The total mass flow of the refrigerant for the respective branch 32, 34 can be regulated as required by means of the valves 40, 42 installed upstream of the battery 16 and the sorption store 18. Thus, the refrigerant is conveyed in essentially equal amounts to the sorption store 18 and to the battery 16 when the valve 42 in the sorption store branch 34 is open and the valve 40 in the battery branch 32 is open. If one of the valves 40, 42 in the battery branch 32 or in the sorption store branch 34 is closed, refrigerant flows through the other branch 34, 32. The battery branch 32 and the sorption branch 34 can in this way be operated in a decoupled manner. Intermediate settings in which the total mass flow of refrigerant is divided in various ratios between the battery branch 32 and the sorption store branch 34 are also possible.

FIG. 4 shows a storage unit 12 according to FIG. 3 in which the cooling circuit 26 is operated in parallel between the battery 16 and the sorption store 18.

As a difference from FIG. 3, the storage unit 12 of FIG. 4 comprises a heat exchanger 46 in the main line 36. The heat exchanger 46 is installed upstream of the pump 28 in the main line 36, 38 in order to provide a further possible way of regulating the temperature of the refrigerant. The refrigerant from the battery branch 32 and from the sorption store branch 34 is thus combined via the junction 44.2 in the main line 36 and subsequently flows through the heat exchanger 46 before the total stream of refrigerant is once again divided between the two branches 32, 34.

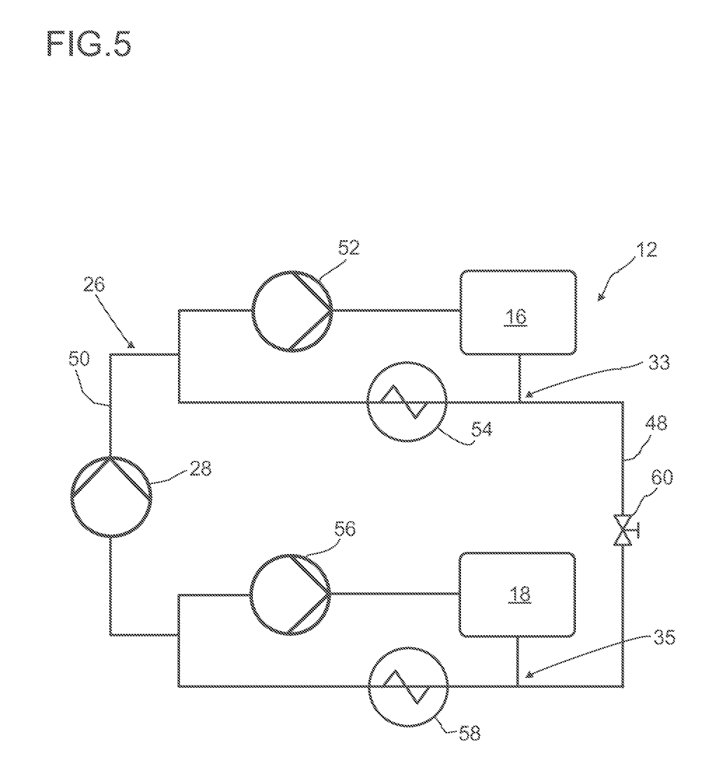

FIG. 5 shows a further embodiment of the storage unit 12 according to the invention, in which the cooling circuit 26 is divided into two decoupled circuits, one for the battery 16 and one for the sorption store 18.

The storage unit 12 of FIG. 5 comprises a cooling circuit 26 which comprises a battery circuit 33 and a sorption store circuit 35. The two circuits 33, 35 are connected to one another via connecting lines 48, 50. Here, the refrigerant is conveyed between the battery circuit 33 and the sorption circuit 35 by means of a pump 28 in one of the connecting lines 48. In the other connecting line 50, a valve 60 is arranged between the battery circuit 33 and the sorption circuit 35 so as to regulate the mass flow of refrigerant which is to be exchanged between the circuits.

To circulate the refrigerant in the battery circuit 33 and the sorption circuit 35, the two circuits 33, 35 are equipped with a pump 52, 56. Furthermore, heat exchangers 54, 58 are provided in the two circuits 33, 35 in order to regulate the temperature of the refrigerant in each of the two circuits 33, 35. In this way, the battery circuit 33 and the sorption circuit 35 can be operated in a decoupled manner. However, refrigerant can also be exchanged between the two circuits 33, 35 via the connection 48, 50 between the battery circuit 33 and the sorption circuit 35.

Refrigerant exchange between the two circuits 33, 35 is advantageous particularly when the refrigerant in the sorption store circuit 35 has been strongly cooled by desorption in the sorption store 18, in particular to less than 20° C., specifically to less than 0° C., and the refrigerant in the battery circuit 33 has been strongly heated by evolution of heat in the battery 16, in particular to above 10° C., specifically to above 35° C. If there is such a temperature gradient between the circuits 33, 35, the valve 60 can be at least partly opened in order to exchange refrigerant between the battery circuit 33 and the sorption store circuit 35. In this way, heat can be removed from the battery circuit 33 and introduced in the sorption circuit 35.

Overall, efficient and simple heat management can be realized by means of the proposed storage unit 12. In particular, the contrary heat requirement of the battery 16 and the sorption store 18 can be optimally exploited by coupling of the cooling circuits. A self-sufficient storage system 12 to which no additional energy has to be supplied is created in this way. Furthermore, the various embodiments of the storage system 12 allow regulation of the refrigerant flow for the battery 16 and the sorption store 18, which can be adapted to different applications. In addition, the heat transfer can in this way be adapted to requirements in order to make optimal heat management possible. Such storage systems 12 can thus easily be matched to the circumstances in mobile and stationary applications, for example integrated into hybrid vehicles or into combined heating and power stations.

### Example

Results of a simulation calculation which compares, by way of example, the heating power and cooling power of a battery and of a sorption store are presented below.

The basis of the calculation is a commercial lithium ion battery having a storage capacity of up to 100 kWh. The maximum permissible temperature of such a battery is about 40° C. The electric energy required by a commercial electric motor is about 20-60 kWh per 100 km. Such electric motors typically have a power of up to 75 kW. The cooling power required is typically up to 2 kW.

A vessel which has a fill volume of 20 liters and is filled with pellets of a metal-organic framework (MOF) of the type 177 as adsorption medium is assumed as sorption store. The MOF type 177 consists of zinc clusters which are joined via 1,3,5-tris(4-carboxyphenyl)benzene as organic linker molecule. The specific surface area (Langmuir) of the MOF is in the range from 4000 to 5000 m²/g. Further information on this type may be found in the U.S. Pat. No. 7,652,132 B2. The pellets have a cylindrical shape with a length of 3 mm and a diameter of 3 mm. Their permeability is 3·10⁻¹⁶ m². The ratio of permeability and the smallest pellet diameter is thus 10-13 m²/m. The porosity of the bed is at least 0.2, for example 0.47.

For a vessel comprising 20 liters of MOF, a weight loading of 30% corresponds to about 2 kg of adsorbed methane. Desorption of this amount requires a desorption energy of 2×10⁶ J. This is calculated from the molar energy of the MOF of 17×10³ J/mol. For 6 vessels, this results in a total energy of 12×10⁶ J which, at a traveling time of about 2 hours, gives a desorption power of about 2 kW.

Overall, the desorption energy of the sorption store thus corresponds to the cooling power required by the battery or the desorption energy of the sorption store is greater than the cooling power required by the battery. The cooling power provided by the sorption store is therefore sufficient, even taking into account further heat losses, to cool the battery and optionally further components such as an air conditioning unit in the vehicle. In this way, a self-sufficient storage system in which the necessary cooling power for the battery corresponds essentially to the desorption power of the sorption store can be formed.

What is claimed is:

1. A storage unit for a drive system in a vehicle, the storage unit comprising at least one sorption store, at least one battery and at least one cooling circuit, wherein the sorption store is coupled via the cooling circuit to the battery, wherein the cooling circuit comprises at least one sorption store circuit and at least one battery circuit.

2. The storage unit of claim 1, wherein the cooling circuit comprises at least one pump which conveys a refrigerant between the battery and the sorption store in the cooling circuit.

3. The storage unit of claim 1, wherein the sorption store circuit and the battery circuit branch off from at least one main line.

4. The storage unit of claim 1, wherein at least one valve for regulating the refrigerant flow is provided in the sorption store circuit or in the battery circuit.

5. The storage unit of claim 1, wherein a heat exchanger and/or at least one pump is arranged in the region of the main line of the cooling circuit.

6. The storage unit of claim 1, wherein the sorption store circuit and the battery circuit form two separate circuits which are connected to one another in the circuit via a connecting line.

7. The storage unit of claim 1, wherein the connecting line comprises at least one pump and at least one valve.

8. The storage unit of claim 1, wherein the sorption store circuit and the battery circuit comprise at least one pump and at least one heat exchanger.

9. A method of operating the storage unit of claim 1, the method comprising heat exchange between the battery and the sorption store via a cooling circuit to which at least one battery and at least one sorption store are connected.

10. The method according to claim 9, wherein the storage unit is operated as a function of a charging state of the battery, a fill level of the sorption store or both.

11. The method according to claim 9, wherein a refrigerant is flown through the battery and the sorption store is varied as a function of the charging state of the battery, the fill level of the sorption store or both.

12. The method according to claim 9, wherein a total stream of the refrigerant is divided into a sorption store circuit and a battery circuit.

13. A drive system comprising the storage unit of claim 1.

14. A vehicle comprising the storage unit of claim 1.
